(19) United States
(12) Patent Application Publication
(10) Pub. No.: US 2019/0210836 A1
(43) Pub. Date: Jul. 11, 2019

(54) ELEVATOR MAINTENANCE ACCESS SYSTEMS

(71) Applicant: Otis Elevator Company, Farmington, CT (US)

(72) Inventor: Arnaud Blanchard, Adon (FR)

(21) Appl. No.: 16/242,117

(22) Filed: Jan. 8, 2019

(30) Foreign Application Priority Data
Jan. 11, 2018 (EP) 18305019.4

(51) Int. Cl. B66B 5/00; B66B 11/02

(52) U.S. Cl. CPC B66B 5/0087; B66B 5/005; B66B 11/0233; B66B 11/0253; B66B 11/0246; B66B 11/0206

(57) ABSTRACT

Elevator maintenance access systems and methods are provided. The elevator maintenance access systems include a frame defining a structural frame of an elevator car and a moveable element moveably coupled to the frame, wherein the moveable element is moveable relative to the frame between a first state and a second state, wherein when the moveable element is in the second state a maintenance gap is formed to enable access from an interior of the elevator car to an exterior of the elevator car.

### BACKGROUND

The subject matter disclosed herein generally relates to elevator systems and, more particularly, elevator maintenance access systems.

Elevator systems require maintenance and inspection to ensure normal operation. Various aspects of maintenance routines can require a technician or other personnel to enter into an elevator shaft, either above or below an elevator car, in order to access components within the elevator shaft. It is advantageous to reduce, minimize, or eliminate the exposure of such personnel within the elevator shaft. Thus, systems for reducing the requirement of elevator shaft access for maintenance operations are advantageous.

### SUMMARY

According to some embodiments, elevator maintenance access systems are provided. The elevator maintenance access systems include a frame defining a structural frame of an elevator car and a moveable element moveably coupled to the frame, wherein the moveable element is moveable relative to the frame between a first state and a second state, wherein when the moveable element is in the second state a maintenance gap is formed to enable access from an interior of the elevator car to an exterior of the elevator car.

In addition to one or more of the features described herein, or as an alternative, further embodiments of the elevator maintenance access systems may include that the moveable element comprises one or more of a first side panel, a second side panel, a rear panel, and an elevator car door.

In addition to one or more of the features described herein, or as an alternative, further embodiments of the elevator maintenance access systems may include that the first side panel includes a car operating panel.

In addition to one or more of the features described herein, or as an alternative, further embodiments of the elevator maintenance access systems may include that the moveable element includes the first side panel, the second side panel, the rear panel, and the elevator car door such that the first side panel, the second side panel, the rear panel, and the elevator car door move as a single moveable unit between the first state and the second state.

In addition to one or more of the features described herein, or as an alternative, further embodiments of the elevator maintenance access systems may include an access system controller operable to control movement of the moveable element between the first state and the second state.

In addition to one or more of the features described herein, or as an alternative, further embodiments of the elevator maintenance access systems may include a frame cover arranged to cover the frame when the moveable element is in the first state.

In addition to one or more of the features described herein, or as an alternative, further embodiments of the elevator maintenance access systems may include a lighting element arranged between the frame cover and the frame to provide lighting within the elevator car.

In addition to one or more of the features described herein, or as an alternative, further embodiments of the elevator maintenance access systems may include that the frame cover is moveable with the moveable element when the moveable element moves from the first state to the second state.

In addition to one or more of the features described herein, or as an alternative, further embodiments of the elevator maintenance access systems may include that the maintenance gap is a fixed gap distance that is based on a percentage of a total height of the elevator car.

According to some embodiments, methods of performing an elevator maintenance operation are provided. The methods include operating an elevator car in a maintenance mode of operation and operating a moveable element from a first state to a second state to expose a maintenance gap such that an exterior of the elevator car is accessible from an interior of the elevator car, wherein the moveable element is moveably mounted to a frame of the elevator car.

In addition to one or more of the features described herein, or as an alternative, further embodiments of the methods may include moving the elevator car to a maintenance position.

In addition to one or more of the features described herein, or as an alternative, further embodiments of the methods may include performing a maintenance operation when the moveable element is in the second state.

In addition to one or more of the features described herein, or as an alternative, further embodiments of the methods may include operating the moveable element from the second state to the first state.

In addition to one or more of the features described herein, or as an alternative, further embodiments of the methods may include that the moveable element comprises one or more of a first side panel, a second side panel, a rear panel, and an elevator car door.

In addition to one or more of the features described herein, or as an alternative, further embodiments of the methods may include that the maintenance gap is a fixed gap distance that is based on a percentage of a total height of the elevator car.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2A is a schematic illustration of an elevator maintenance access system in accordance with an embodiment of the present disclosure, shown in a first state;

FIG. 2B is a schematic illustration of the elevator maintenance access system of FIG. 2A shown in a second state;

FIG. 3 is a schematic illustration of a portion of an elevator maintenance access system in accordance with an embodiment of the present disclosure;

FIG. 4 is a schematic illustration of an elevator maintenance access system in accordance with an embodiment of the present disclosure; and

FIG. 5 is a flow process for performing a maintenance operation on an elevator system in accordance with an embodiment of the present disclosure.

### DETAILED DESCRIPTION

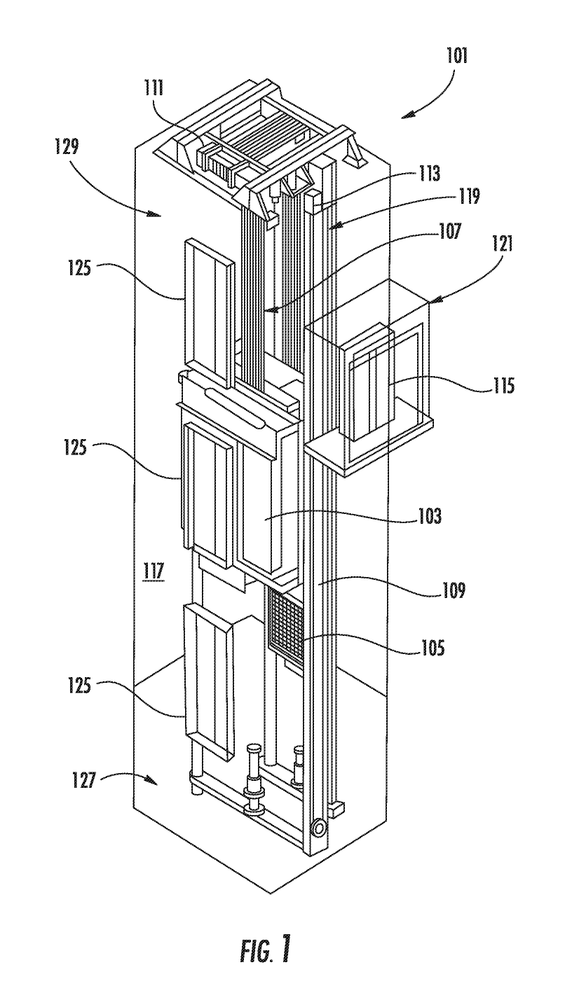

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art, such as in the hoistway, elevator shaft, or in a machine room.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

As discussed above, elevator systems require maintenance to be performed within the elevator shaft 117. As shown in FIG. 1, the elevator shaft 117 includes a pit 127 and a shaft top 129. The pit 127 and the shaft top 129 are locations within the elevator shaft that may require a mechanic or other person to enter the elevator shaft 117 to perform maintenance or take other action. Further, various components along the elevator shaft 117 between the pit 127 and the shaft top 129 can include components that require maintenance from time to time, such as landing door components, the guide rails 109, etc.

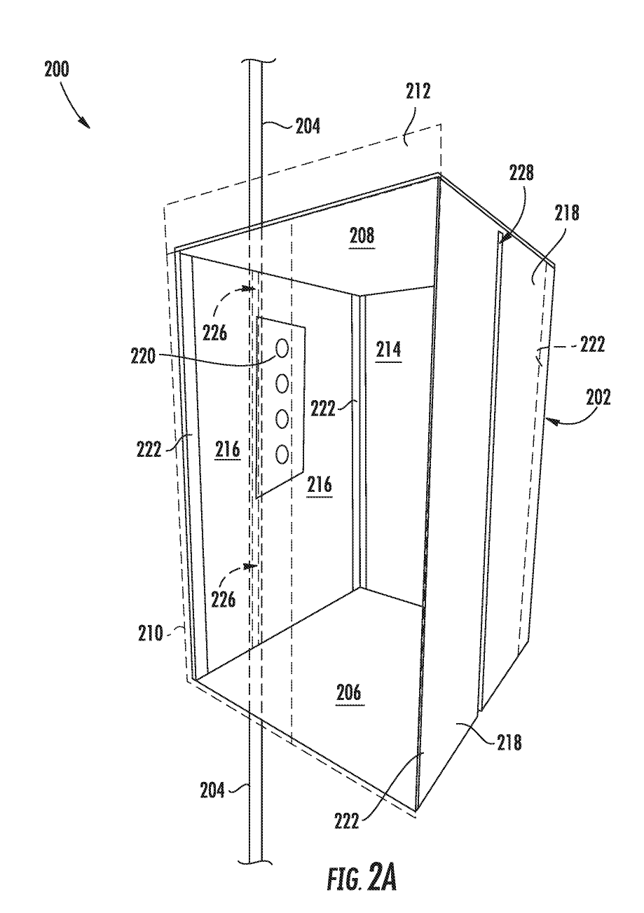

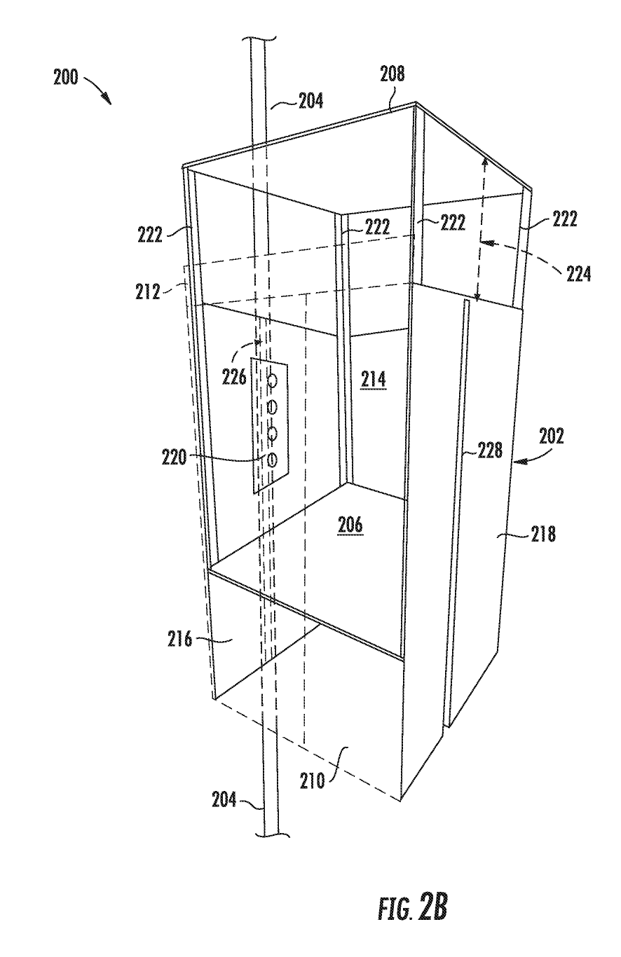

Turning now to FIGS. 2A-2B, schematic illustrations of an elevator maintenance access system 200 in accordance with an embodiment of the present disclosure are shown. FIG. 2A illustrates the elevator maintenance access system 200 in a first state which is employed during normal operation of an elevator car 202 within an elevator system (e.g., similar to the elevator system 101 shown and described with respect to FIG. 1). FIG. 2B illustrates the elevator maintenance access system 200 in a second state which is employed during maintenance operations.

As shown, the elevator car 202 is moveable along a guide rail 204 (with a second guide rail not shown for clarity purposes). The elevator car 202 has a floor 206, a ceiling 208, a plurality of wall panels 214, 216, 218, and an elevator car door 210 (shown in FIG. 2B and omitted in FIG. 2A for clarity). The elements of the elevator car 202 define a passenger space therein, as will be appreciated by those of skill in the art. The elevator car 202 further includes a header 212 that can include locking/unlocking mechanisms for operation with landing doors of the elevator system, as will be appreciated by those of skill in the art.

The wall panels of the elevator car 202 include a rear panel 214, a first side panel 216, and a second side panel 218. Along with the elevator car door 210, the passenger space is defined. As shown, the first side panel 216 can include a car operating panel 220 for enabling control and operation of the elevator car 202 within an elevator shaft. The wall panels 214, 216, 218 and the elevator car door 210 are moveably mounted to a frame 222 and the floor 206 and the ceiling 208 are fixedly attached to the frame 222. As noted, the illustration of FIG. 2A is of the elevator maintenance access system 200 in a first state, with the wall panels 214, 216, 218 and the elevator car door 210 (not shown in FIG. 2A) positioned to define the passenger space of the elevator car 202. The frame 222 is a structural frame of the elevator car 202 and enables the elevator car 202 to suspend from a roping or other system for movement of the elevator car 202 within an elevator shaft.

However, as shown in FIG. 2B, the wall panels 214, 216, 218 and the elevator car door 210 are moved into a second state. In the illustration of FIG. 2B, the header 212 is also moved along with the elevator car door 210. As the wall panels 214, 216, 218 and the elevator car door 210 are moved from the first state to the second state, a maintenance gap 224 is formed between a top of the wall panels 214, 216, 218 and the elevator car door 210 and the ceiling 208. The maintenance gap 224 is a gap or space that allows a mechanic or other personnel to access an exterior of the elevator car 202 without having to enter the elevator shaft. That is, the maintenance gap 224 enables access from an interior of the elevator car 202 to an exterior of the elevator car 202. Further, the ceiling 208 of the elevator car 202 will provide protection to the personnel within the elevator car 202 while performing a maintenance operation.

As shown, the side panels 216, 218 include respective guide rail channels 226, 228. The guide rail channels 226, 228 are provided to enable the respective side panels 216, 218 to move relative to the guide rail 204. In some embodiments, the guide rail channels 226, 228 may be tracks that are arranged to moveably engage with the guide rail 204 or, in some embodiments, the guide rail channels 226, 228 may be arranged to not contact the guide rail 204. Further, in some embodiments, the guide rail channels 226, 228 may be gaps or spaces within the side panels 216, 218 such that the side panels 216, 218 are composed of two separate sub-panels that are divided about the guide rail 204.

In some embodiments, the wall panels 214, 216, 218 and the elevator car door 210 are fixedly connected to each other to form a single moveable unit that is moveable from the first state to the second state along the frame 222. In other embodiments, each of the wall panels 214, 216, 218 and the elevator car door 210 may be independently moveable from the first state to the second state, and in other embodiments, various combinations of the wall panels 214, 216, 218 and the elevator car door 210 may be moveable separately and/or together.

In some embodiments, the moveable elements (i.e., the wall panels 214, 216, 218 and the elevator car door 210) are driven by a motor or other type of powered controller and/or actuator (e.g., pistons, gears, etc.). Thus, when a mechanic desires to perform a maintenance operation, they can enter the elevator car 202 and perform an opening operation to move the moveable elements (210, 214, 216, 218) from the first state to the second state and thus gain access to the elevator shaft, without having to enter the elevator shaft itself. The control operation can be controlled using one or more elements located on the car operating panel 220, or a controller located elsewhere that is associated with the elevator car 202. In other embodiments, the moveable elements may be manually operated, using handles, locks, etc. to allow a mechanic to manually open and close the maintenance gap 224.

The maintenance gap 224 can be predetermined such that the movement of the moveable elements (210, 214, 216, 218) can be fixed or limited. For example, the maintenance gap 224 may be a fixed gap distance that is based on a percentage of a total height of the elevator car 202 (e.g., a distance from the floor 206 to the ceiling 208). For example, in one non-limiting example, the maintenance gap may be set to be about one eighth of a total height of the elevator car 202. Accordingly, the maintenance gap distance can be based on the specific elevator car dimensions. However, in other embodiments, the maintenance gap 224 can be controlled by the mechanic to a desired opening gap distance, and such maintenance gap 224 may not be limited or predetermined. Further, in some embodiments, the maintenance gap 224 may be a fixed absolute distance.

Although shown in FIGS. 2A-2B with the moveable elements (210, 214, 216, 218) moving downward relative to the frame 222, such arrangement is not to be limiting. For example, in some embodiments, the moveable elements (210, 214, 216, 218) may move upward relative to the frame 222, thus forming a maintenance gap adjacent the floor 206 (rather than the ceiling 208). Further, in some embodiments, the moveable elements (210, 214, 216, 218) may be moveable both upward and downward relative to the frame 222.

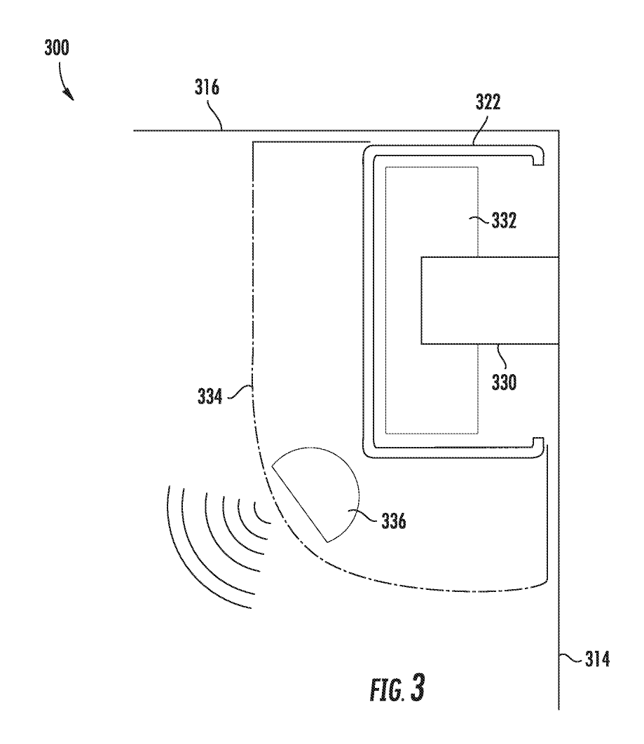

Turning now to FIG. 3, a schematic illustration of a corner of an elevator maintenance access system 300 in accordance with a non-limiting embodiment of the present disclosure is shown. The elevator maintenance access system 300 represents a portion of a system similar to that shown and described with respect to FIGS. 2A-2B. As shown, the elevator maintenance access system 300 has a frame 322 with a first side panel 316 and a rear panel 314 movably mounted to the frame 322. In this illustration, the rear panel 314 and the first side panel 316 are shown as a unitary or continuous structure, although such configuration is not to be limiting (e.g., the various panels can be separate elements).

In this embodiment, the rear panel 314 includes a panel guide element 330 that engages with and/or is moveable along a frame guide element 332. In some embodiments, the frame guide element 332 is part of or fixedly connected to the frame 322. For example, the frame guide element 332 may be a run or channel that the panel guide element 330 can engage within and move along during transition between the first state and the second state. In some embodiments, the panel guide element 330 may be a roller that runs within a channel defined by the frame guide element. In other embodiments, the panel guide element 330 can be a gear chain or similar element that engages along the frame guide element 332. In such embodiment, the frame guide element 332 can have a toothed arrangement that the chain of the panel guide element 330 moves along. Other engagement or guide arrangements are possible without departing from the scope of the present disclosure, and the above descriptions are provided merely for example and explanation.

Also shown in FIG. 3 is an optional frame cover 334. The frame cover 334 is arranged to cover the frame 322 such that the frame cover is an aesthetic cover that covers the frame 322 and provides an aesthetic surface within the elevator car when in the first state. The frame cover 334 can be fixedly attached to the frame 322 or may be attached to one or more of the panels 314, 316. When attached to the panels 314, 316, when the moveable elements are moved, the frame cover 334 will move with the moveable elements. Also shown in FIG. 3, an optional lighting element 336 can be provided within the frame cover 334. The lighting element 336 can provide illumination within the elevator car. In some embodiments, the lighting element 336 can be used for illumination during normal operation of the elevator car (e.g., in the first state) and, in some embodiments, the lighting element 336 can be operable in the second state to provide illumination during a maintenance operation.

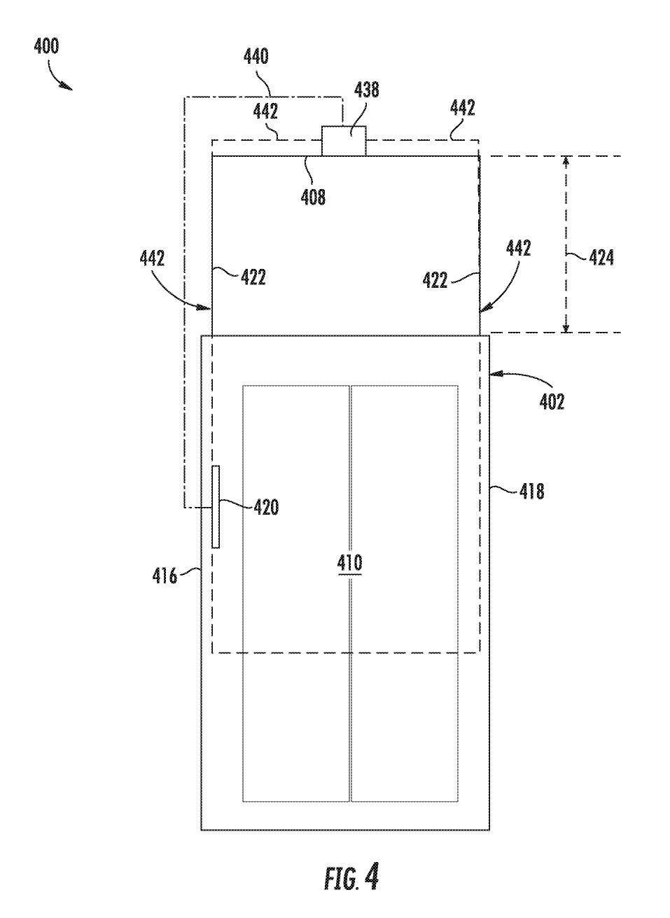

Turning now to FIG. 4, a front elevation schematic illustration of an elevator maintenance access system 400 in accordance with an embodiment of the present disclosure is shown. The elevator maintenance access system 400 is similar to that shown and described above. As shown, an elevator car 402 has a frame 422 with moveable elements 410, 416, 418 moveable along the frame 422 as described above. In this illustration one moveable element 410 is an elevator car door, another moveable element 416 is a first side panel, and another moveable element 418 is a second side panel. A car operating panel 420 of the elevator car 402 is part of or mounted to the first side panel 416.

As shown, the car operating panel 420 is operably connected to an access system controller 438 through a communication link 440. The communication link 440 can be an electrical connection, an electro-mechanical connection, a wireless connection, or other type of connection that enables operation at the car operating panel 420 to control operation of the elevator maintenance access system 400 (e.g., to control movement of the moveable elements between first and second states). As shown in FIG. 4, the moveable elements 410, 416, 418 are shown in the second state such that a maintenance gap 424 is formed between a top of the moveable elements 410, 416, 418 and a ceiling 408 of the elevator car 402.

The access system controller 438, as shown, is located on an exterior of the elevator car 402, such as on the outside of the ceiling 408 of the elevator car 402. However, the access system controller of elevator maintenance access system of the present disclosure can be located in any number of locations on or near an elevator car and/or elevator system, without departing from the scope of the present disclosure.

The access system controller 438 is operably connected to an actuating system 442 that is coupled to the moveable elements 410, 416, 418 to move the moveable elements 410, 416, 418 relative to the frame 422. The actuating system 400 can include a motor, piston system, gear system, chain system, or other drive and/or actuating elements/components to move the moveable elements 410, 416, 418 relative to the frame 422.

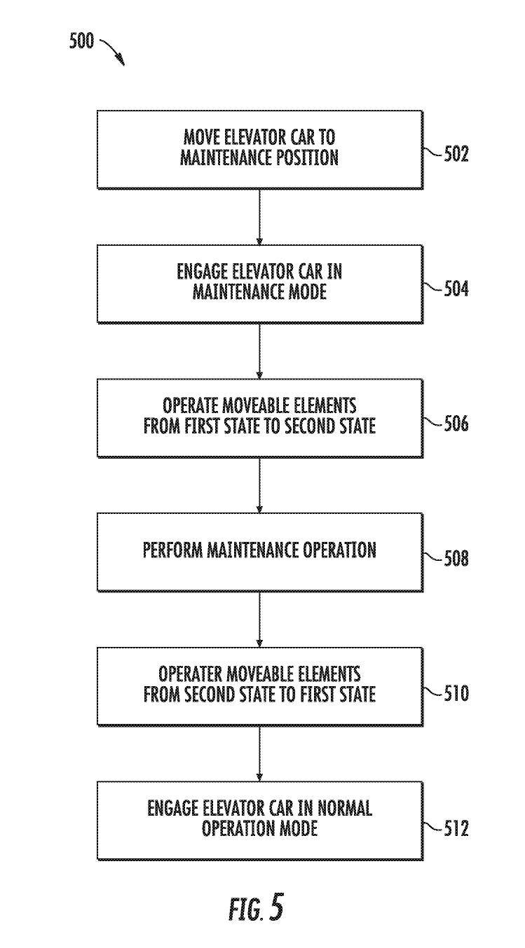

Turning now to FIG. 5, a flow process 500 for controlling an elevator system in accordance with an embodiment of the present disclosure is shown. The flow process 500 may be performed using elevator maintenance access systems as shown and described herein and/or variations thereof.

At block 502, an elevator car can be moved to a maintenance position within an elevator shaft. For example, a mechanic can control the elevator car to move the elevator car to a desired position within an elevator shaft in order to perform a maintenance operation at the maintenance position. Such maintenance positions can include, but are not limited to, elevator system landing doors, elevator shaft top, elevator pit, etc.

At block 504, the mechanic can control the elevator car and elevator system to engage a maintenance mode of operation. The maintenance mode of operation can be a limited operation mode of the elevator system that prevents elevator landing calls to be made. Further, such mode of operation can be configured to prevent unauthorized or unintended movement of the elevator car. In some non-limiting embodiments, the mechanic may be able to move the elevator car within the elevator shaft even when in the maintenance mode of operation, as will be appreciated by those of skill in the art.

In some embodiments, the operations of the preceding blocks 502, 504 of the flow process 500 can be reversed, such that the maintenance mode of operation (block 504) is engaged prior to moving the elevator car to the maintenance position (block 502).

At block 506, the mechanic can operate the elevator system to move one or more moveable elements of the elevator car from a first state to a second state. The movement of the moveable elements will expose a maintenance gap between the moveable element and a ceiling or floor of the elevator car, as shown and described above. The operation at block 506 can be electronic, mechanical, and/or manual. In an electronic control operation, the mechanic can use an electronic controller to control a motor or other actuating device to drive and move the moveable elements from the first state to the second state. In some embodiments, a mechanical operation or a manual operation can be employed to move the moveable elements from the first state to the second state (and back).

At block 508, the mechanic can access the exterior of the elevator car and/or components within an elevator shaft through the maintenance gap to perform a maintenance operation. For example, the mechanic can access a landing door lintel and components thereof, access an elevator car door header, and/or access components within an elevator shaft.

At block 510, the mechanic can then operate the moveable elements back to the first state, from the second state, to close the maintenance gap.

At block 512, the elevator can be re-engaged into a normal operation mode.

In some embodiments, after performing a maintenance operation at block 508, the mechanic may move the elevator car to a different (e.g., second) maintenance position, without closing the maintenance gap. Thus, the flow process 500 is not intended to be limiting, but rather is provided as an example operation, although other actions and/or different orders of actions can be used without departing from the scope of the present disclosure.

In accordance with embodiments of the present disclosure, elevator cars are arranged with wall/door panels that include a guide system for enabling movement of the wall/door panels relative to a frame of the elevator car. Accordingly, the wall/door panels can be lowered or raised relative to the frame forming a maintenance gap and enabling access to the exterior of the elevator car from the interior of the elevator car. For example, the maintenance gap created between the panels and an elevator car ceiling can be used by a mechanic to perform elevator shaft equipment maintenance.

Advantageously, embodiments provided herein enable improved/more efficient elevator maintenance operations and can reduce maintenance costs. Advantageously, embodiments provided herein enable a mechanic to not have to climb on a ladder and/or to work from a platform. In contrast, the mechanic is able to remain standing on the floor of the elevator while accessing components located exterior to the elevator car. Moreover, advantageously, the mechanic can be protected from falling into an elevator shaft due to a limitation on the size of the maintenance gap and/or keeping a portion of the wall panels from fully exposing an elevator shaft. As such, in accordance with some embodiments, the moved wall panels of the elevator car can function as a guardrail to ensure the safety of a mechanic. Furthermore, embodiments provided herein can protect a mechanic from falling objects due to the mechanic being located within the elevator car during the maintenance operation.

Those of skill in the art will appreciate that various example embodiments are shown and described herein, each having certain features in the particular embodiments, but the present disclosure is not thus limited. That is, features of the various embodiments can be exchanged, altered, or otherwise combined in different combinations without departing from the scope of the present disclosure.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. An elevator maintenance access system comprising:
a frame defining a structural frame of an elevator car; and
a moveable element moveably coupled to the frame, wherein the moveable element is moveable relative to the frame between a first state and a second state, wherein when the moveable element is in the second state a maintenance gap is formed to enable access from an interior of the elevator car to an exterior of the elevator car.

2. The elevator maintenance access system of claim 1, wherein the moveable element comprises one or more of a first side panel, a second side panel, a rear panel, and an elevator car door.

3. The elevator maintenance access system of claim 1, wherein the first side panel includes a car operating panel.

4. The elevator maintenance access system of claim 2, wherein the moveable element includes the first side panel, the second side panel, the rear panel, and the elevator car door such that the first side panel, the second side panel, the rear panel, and the elevator car door move as a single moveable unit between the first state and the second state.

5. The elevator maintenance access system of claim 1, further comprising an access system controller operable to control movement of the moveable element between the first state and the second state.

6. The elevator maintenance access system of claim 1, further comprising a frame cover arranged to cover the frame when the moveable element is in the first state.

7. The elevator maintenance access system of claim 6, further comprising a lighting element arranged between the frame cover and the frame to provide lighting within the elevator car.

8. The elevator maintenance access system of claim 6, wherein the frame cover is moveable with the moveable element when the moveable element moves from the first state to the second state.

9. The elevator maintenance access system of claim 1, wherein the maintenance gap is a fixed gap distance that is based on a percentage of a total height of the elevator car.

10. A method of performing an elevator maintenance operation, the method comprising:
operating an elevator car in a maintenance mode of operation; and
operating a moveable element from a first state to a second state to expose a maintenance gap such that an exterior of the elevator car is accessible from an interior of the elevator car, wherein the moveable element is moveably mounted to a frame of the elevator car.

11. The method of claim 10, further comprising moving the elevator car to a maintenance position.

12. The method of claim 10, further comprising performing a maintenance operation when the moveable element is in the second state.

13. The method of claim 12, further comprising operating the moveable element from the second state to the first state.

14. The method of claim 10, wherein the moveable element comprises one or more of a first side panel, a second side panel, a rear panel, and an elevator car door.

15. The method of claim 10, wherein the maintenance gap is a fixed gap distance that is based on a percentage of a total height of the elevator car.
